(19) United States
(12) Patent Application Publication
(10) Pub. No.: US 2025/0053001 A1
(43) Pub. Date: Feb. 13, 2025

(54) PROTECTION ASSEMBLY FOR AN ULTRASOUND CLEANING DEVICE FOR CLEANING AN OPTICAL SURFACE

(71) Applicant: VALEO SYSTEMES D'ESSUYAGE, La Verriere (FR)

(72) Inventor: Frederic BRETAGNOL, La Verriere (FR)

(73) Assignee: VALEO SYSTEMES D'ESSUYAGE, La Verriere (FR)

(21) Appl. No.: 18/719,289

(22) PCT Filed: Dec. 14, 2022
(86) PCT No.: PCT/EP2022/085793

§ 371 Date: Jun. 13, 2024

(30) Foreign Application Priority Data
Dec. 16, 2021 (FR) FR2113719

(51) Int. Cl. G02B 27/00

(52) U.S. Cl. CPC G02B 27/0006

(57) ABSTRACT

The present invention relates to a protection assembly for a cleaning assembly including a cleaning unit and an optical surface, with the cleaning unit having at least one wave transducer to be acoustically coupled to the optical surface. The protection assembly including a mechanical protection element configured to cover the wave transducer, such that the wave transducer is between the mechanical protection element and the optical surface. The mechanical protection element is configured to define, with the optical surface, at least one opening which allows the ultrasonic wave to propagate on the optical surface outside the mechanical protection element. The protection assembly includes a sealing element disposed close to the opening and capable of limiting the passage of liquid through the opening.

### TECHNICAL FIELD

The present invention relates to an assembly for protecting a unit for cleaning a body in contact with an optical surface using ultrasound waves.

### BACKGROUND OF THE INVENTION

In various fields, it is necessary to overcome the effects associated with the build-up of a body, notably raindrops, ice or snow, on an optical surface.

It is known practice to cause drops of a liquid to rotate in order to remove them from a surface. However, such a technique is not suitable for surfaces with an area greater than a few square centimeters.

The use of an electrical field to control the hydrophobic property of a surface is also known, for example from KR 2018 0086173 A1. This technique, known by the acronym EWOD (which stands for ElectroWetting On Devices), consists in applying a potential difference between two electrodes so as to electrically polarize the surface and change the wetting properties thereof. By controlling the location of the polarization, the drop can then be moved. However, this technique can be implemented only with specific materials and requires the electrodes to be positioned particularly precisely over the entire surface the wetting properties of which are to be controlled.

It is also well-known practice to apply a mechanical force to the liquid, for example by means of a wiper on the windshield of a motor vehicle. However, a wiper limits the field of view accessible to the driver. It also spreads the greasy particles deposited on the surface of the windshield. In addition, the wiper blade rubbers need to be renewed regularly.

Moreover, autonomous motor vehicles include a large number of sensors to determine the distances and speeds of other vehicles on the road. Such sensors, for example lidars, are also subject to the weather and mud splashes and require frequent cleaning. However, a windshield wiper is not suitable for cleaning the small area of such a sensor. In addition, there is a need for such sensors to be compact, in order to be easily integrated within the vehicle. US 2016/0170203 A1 describes a device for cleaning a camera on a vehicle, using ultrasound waves.

Such systems employ a piezoelectric element to generate ultrasound waves, and the piezoelectric element is generally exposed on an external face of the optical surface that is to be cleaned. The piezoelectric element is therefore exposed on the outside and carries the risk of becoming damaged by the impingement of external elements, such as insects or small objects such as stones.

In addition, the piezoelectric element is generally coupled to conducting electrodes able to generate the acoustic wave by converting the electrical current into a mechanical wave. The exposure of such electrodes to liquids such as liquid water, or to condensation, may give rise to short circuits, causing the system to malfunction or even break.

There is therefore a need to protect cleaning units that clean an optical surface using ultrasound waves, without excessively limiting their effectiveness, notably without excessively limiting the propagation of the waves.

In order to do this it is known practice to position, facing the piezoelectric elements, bonded-on protective systems made of glass or of polymer, notably so as to protect the electrodes.

However, in such cases, it is necessary either to optimize the thickness of bonding near the interface between the optical surface and the piezoelectric element, or to minimize the lateral part of the protective system, so as to absolutely minimize the absorption of the waves generated by the transducer.

Provision may also be made for the surface of the substrate to be covered with a thin insulating coating, which may be ceramic or hybrid in nature, so as to afford mechanical protection to the transducer. However, such a thin layer does not provide reliable protection in the event of a significant impact, notably one at high speed, and neither does it solve the problem of fouling with soft matter, for example flies, which disrupt the operation of the transducer. Such a layer thus needs to be cleaned using a fluid. The cleaning of the optical surface thus requires the cleaning of the transducer also, which leads to an overconsumption of cleaning fluid. In addition, in the case of a piezoelectric material, a surface layer has an influence on the carriage of the generated sound waves, and therefore lessens the effectiveness of the device.

There is therefore a need for a cleaning assembly, comprising a cleaning unit and an optical surface, to effectively move a body, notably a liquid, away from the optical surface, the assembly at the same time being robust in terms of mechanical stresses and also fluidtight

### SUMMARY OF THE INVENTION

The present invention relates to a protection assembly comprising a cleaning unit and an optical surface, the cleaning unit comprising at least one wave transducer intended to be acoustically coupled to the optical surface,
the protection assembly comprises a mechanical protection element configured to cover the wave transducer so that the wave transducer is comprised between the mechanical protection element and the optical surface,
said mechanical protection element being configured to define, with the optical surface, at least one opening able to allow the ultrasonic wave to propagate over the optical surface outside of the mechanical protection element;
the protection assembly comprises a sealing element disposed near said opening and able to limit the passage of liquid through the opening.

The combination of a mechanical protection element, defining an opening for the passage of the ultrasonic waves, and of a sealing element in the vicinity of the opening, allows the transducer to be protected while at the same time allowing the cleaning assembly to perform its function.

According to one embodiment, the opening may be configured to have a dimension, normal to a direction of propagation of the ultrasonic waves, that is greater than or equal to half the amplitude of the ultrasonic waves generated by the transducer.

The dimensions of the opening thus allow the ultrasonic waves to pass, while being small enough to afford mechanical protection over the largest possible zone around the transducer, and facilitate the sealing of the cleaning assembly.

According to one embodiment, the sealing element may comprise a hydrophobic or superhydrophobic coating in the vicinity of the opening.

For example, the hydrophobic or superhydrophobic coating may be configured to at least partially cover the optical surface and/or the hydrophobic or superhydrophobic coating may at least partially cover the mechanical protection element.

Such a coating does not induce any attenuation of the ultrasonic waves generated by the transducer, but at the same time makes it possible to improve the sealing of the cleaning assembly, notably when the opening is a slot the height of which is small in comparison with a height of the mechanical protection element. Such is the case when the opening has a height, having a dimension normal to the direction of propagation of the ultrasonic waves, that is of the order of the amplitude of the ultrasonic waves generated.

According to one embodiment, the sealing element may comprise an attachment element configured to be placed between the mechanical protection element and the optical surface.

Such an embodiment allows the function of attaching the mechanical protection element to the optical surface to be combined with the sealing function, thus making the mechanical protection element easier to fit and minimizing the cost thereof.

In addition, the fixing element may comprise an adhesive foam or an adhesive able to allow some of the ultrasonic waves generated by the wave transducer to propagate through the opening.

Such adhesive foams or adhesives may have properties such that they absorb only to a very small extent the ultrasonic waves generated, while at the same time affording good sealing of the cleaning assembly. In particular, adhesive foams or adhesives having a high degree of hardness are able to afford such an effect. Adhesive foams made of neoprene are, in practice, the fixing elements that slow the ultrasonic waves the least.

Alternatively, the sealing element may comprise a rubber component placed in the opening, attached to the mechanical protection element, and configured to be in contact with the optical surface.

Such a component provides the sealing of the cleaning assembly while at the same time allowing the ultrasonic waves to pass, notably when the contact with the optical surface is small, particularly when this contact is linear contact.

In addition, the mechanical protection element may be configured to be attached to the optical surface by an adhesive or an adhesive foam spread on each side of the opening.

Such an embodiment makes it possible to provide good sealing of the cleaning assembly between the optical surface and the mechanical protection element, even away from the opening.

According to one embodiment, the protection assembly may further comprise a covering of a material that absorbs electromagnetic waves and is able to limit the electromagnetic radiation from the wave transducer outside of the cleaning assembly.

Thus, the cleaning assembly may be positioned next to other electronic devices, performing other functions, without disrupting the operation thereof.

In addition, the covering of a material that absorbs electromagnetic waves may be applied at least partially:
to an interior face of the mechanical protection element facing the transducer or on an exterior face of the mechanical protection element opposite to the transducer; and/or
to a face of the optical surface between the optical surface and the transducer, or to a face of the optical surface opposite to the transducer.

What is meant by a “material that absorbs electromagnetic waves” is any material that has a property of absorbing electromagnetic waves.

For example, the covering of a material that absorbs electromagnetic waves may be a metallic layer or else a layer of textile printed with at least one conducting ink in at least one pattern comprising printed zones and non-printed zones in an arrangement suited to a corresponding range of absorption frequencies.

Thus, the covering may constitute a Faraday cage around the transducer, minimizing the electromagnetic radiation from the transducer outside of the cleaning assembly.

According to one embodiment, the optical surface may be one of the following:
a motor vehicle surface, for example selected from a windshield of a vehicle and a glazing of a rear-view mirror;
a surface of an optical device, for example selected from a camera lens, a lens of a pair of spectacles and a sensor, in particular a probe, for example a Pitot tube, or
a protection element of such an optical device.

A second aspect of the invention relates to a cleaning unit for an optical surface, comprising at least one wave transducer intended to be acoustically coupled to the optical surface. The wave transducer comprises a piezoelectric element and electrodes of opposite polarity in contact with the piezoelectric element, and is configured to generate at least one ultrasonic wave propagating in the optical surface. The cleaning unit further comprises the protection assembly according to the first aspect of the invention.

A third aspect of the invention relates to a cleaning assembly comprising:
an optical surface;
a cleaning unit for cleaning the optical surface according to the second aspect of the invention.

### BRIEF DESCRIPTION OF DRAWINGS

Other features and advantages of the invention will also become apparent both from the following description and from several exemplary embodiments given by way of nonlimiting indication with reference to the attached schematic drawings, in which:

FIG. 1 shows a view in cross section of a cleaning assembly according to one embodiment of the invention;

FIG. 2 is a three-dimensional view of a transducer of a cleaning unit of the cleaning assembly according to one embodiment of the invention;

FIG. 3a depicts a sealing element of a protection assembly of the cleaning assembly according to a first embodiment of the invention;

FIG. 3b depicts a sealing element of a protection assembly of the cleaning assembly according to a second embodiment of the invention; and

FIG. 3c depicts a sealing element of a protection assembly of the cleaning assembly according to a third embodiment of the invention.

### DETAILED DESCRIPTION OF THE INVENTION

It should first of all be noted that, although the figures set out the invention in detail for its implementation, they may, of course, be used to better define the invention if necessary. It should also be noted that, in all of the figures, elements that are similar and/or perform the same function are indicated by the same numbering.

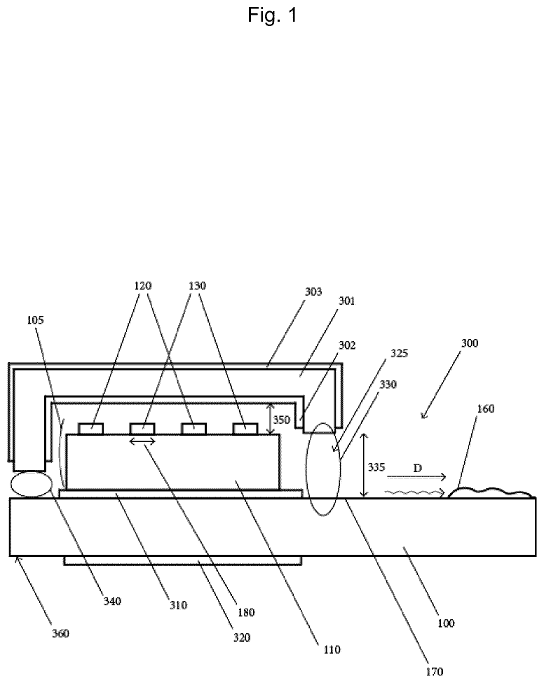

FIG. 1 depicts a cleaning assembly according to one embodiment of the invention, comprising:
an optical surface 100;
a cleaning unit for cleaning the optical surface, comprising a transducer 105, the transducer comprising a substrate 110, a first electrode 120 and a second electrode 130. The electrodes 120 and 130 cover a first face of the substrate. In FIG. 1, the substrate is between the electrodes 120 and 130 and the optical surface 100. However, alternatively, the electrodes 120 and 130 may be between the substrate 110 and the optical surface 100.

The substrate 110 is a piezoelectric element, comprising for example 128° Y-cut lithium niobate or any other piezoelectric material. The substrate 110 may have the shape of a plate having a thickness less than or equal to 500 micrometers, μm.

The first and second electrodes 120 and 130 may be connected to a voltage generator, not shown in FIG. 1, which supplies them with electrical power.

In the example shown, the optical surface 100 takes the form of a plate and has an upper face 170 in contact with the external environment. However, no restriction is imposed on the shape of the optical surface 100, which may in particular be curved. In the example shown, it is covered by a body 160, such as a film of water for example. No restriction is imposed on the body 160, which may be a solid body, such as an insect, a fatty body and/or a body of a liquid other than water. The body may have a part in the solid state and a part in the liquid state. For example, the body may be water and be formed of a frosty, icy or snowy portion and a liquid portion in contact with the frosty, icy or snowy portion, respectively.

The body in the liquid state may take the form of at least one drop or at least a film. “Film” means a thin film formed on the optical surface 100. The film may be continuous or discontinuous.

The body may be aqueous. In particular, it may be rainwater or dew water. The rainwater and/or dew water may in particular contain particles. Dew water forms a mist on the surface of a support. It results from the condensation on the support, under appropriate pressure and temperature conditions, of water in vapor form contained in the air. The body 160 may have been deposited by condensation before solidifying on the support.

The body in the solid state may be frost, ice or snow. The body in the liquid state may be a layer or at least one drop, for example mist.

The body 160 may be in contact with the upper face 170 of the optical surface 100 to which the transducer 105 is attached, or the opposite face from the face 170 of the optical surface 100 to which the transducer is attached. The body 160 may be in contact with the face of the optical surface 100 to which the transducer 105 is attached and another body may be in contact with the opposite face.

To produce such a cleaning assembly, the first and second electrodes may be formed by an evaporation or spraying process and shaped by photolithography. They may be made of chromium, or aluminum, or a combination of an adhesion-promoting layer such as titanium with a conducting layer such as gold.

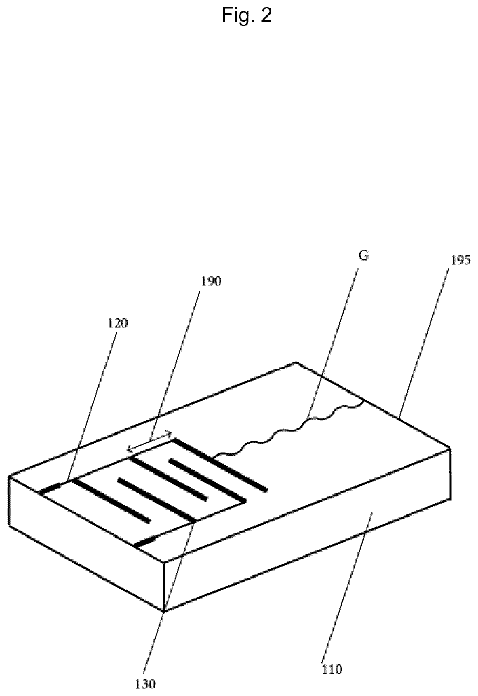

As shown in FIG. 2, the first and second electrodes 120 and 130 form combs. However, no restriction is imposed, according to the invention, on the shape of the first and second electrodes 120 and 130.

Each comb has a base and a row of fingers extending parallel to one another from the base. The first and second combs are interlaced. Each of the fingers of the first comb, respectively of the second comb, may have a width 180, indicated in FIG. 1, equal to the fundamental wavelength of the ultrasonic wave divided by 4 and a spacing 190 between two consecutive fingers of a comb determines the resonant frequency of the transducer 105 that the person skilled in the art may easily determine. An alternating voltage is applied by the generator, such that the transducer generates an ultrasonic surface wave.

For a liquid body 160, a transducer 105 synthesizing a surface wave of fundamental frequency between 0.1 MHz and 1000 MHz, preferably between 10 MHz and 100 MHz, for example equal to 40 MHz, is well suited to ensuring the movement of the liquid body 160. In the alternative form whereby the film of water is in the form of ice or frost, the transducer is also well suited to causing the film of water to melt, through the application of the energy of the surface ultrasonic wave and the heat transfer that it generates.

The waves generated at the surface may have an amplitude of less than 500 nm, notably less than 100 μm, or even than 10 nm.

The transducer 105 may be bonded to the optical surface 100, notably by means of a polymer adhesive that also acoustically couples the transducer 105 to the optical surface 100. The adhesive may be UV-curable. It is, for example, an epoxy resin. The transducer 105 may be attached by molecular adhesion or by means of a thin metallic layer that provides the adhesion between the optical surface 100 and the substrate 110. The layer can be made from a metal or an alloy with a low melting point, i.e. having a melting point below 200° C., for example an indium alloy. As a variant, the metallic layer can be made from a metal or an alloy having a melting point above 200° C., for example an aluminum and/or gold alloy. An example of bonding via molecular adhesion is described in “Glass-on-LiNbO3 heterostructure formed via a two-step plasma activated low-temperature direct bonding method”, J. Xu et al., Applied Surface Science 459 (2018) 621-629, doi: 10.1016/j.apsusc.2018.08.031. According to another variant, the transducer 105 may be fixed to the optical surface 100 by means of a process including a step of melting a portion of the substrate 110 and/or a portion of the optical surface 100, followed by a step consisting in compressing the substrate 110 and the optical surface 100 together, the respective molten portions of the optical surface 100 and of the substrate 110 being in contact with each other. According to another variant, the transducer 105 may be fixed to the optical surface 100 by means of a process including depositing bonding layers made of a low-melting alloy on a portion of the transducer 105 and on a portion of the optical surface 100, respectively, at least partially melting said bonding layers, then compressing the substrate 110 and the optical surface 100, the faces of the bonding layers that are the opposite faces from those facing the optical surface 100 and the substrate 110 being brought into contact with each other during the compression.

The bonding layers may be applied by cathodic sputtering, or using an evaporation technique used in the field of the application of thin layers.

The characteristics set out hereinabove do not afford the transducer 105 protection against the impact of solids or against liquids, able to lead to a reduction in the performance of the transducer 105 or even damage to same to the point that it is prevented from working.

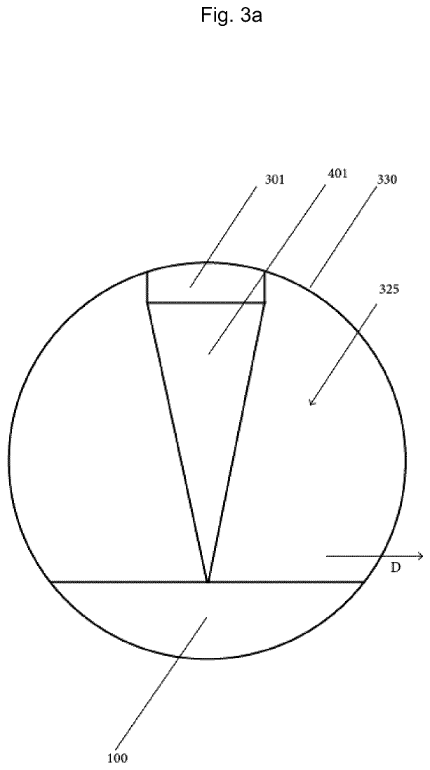

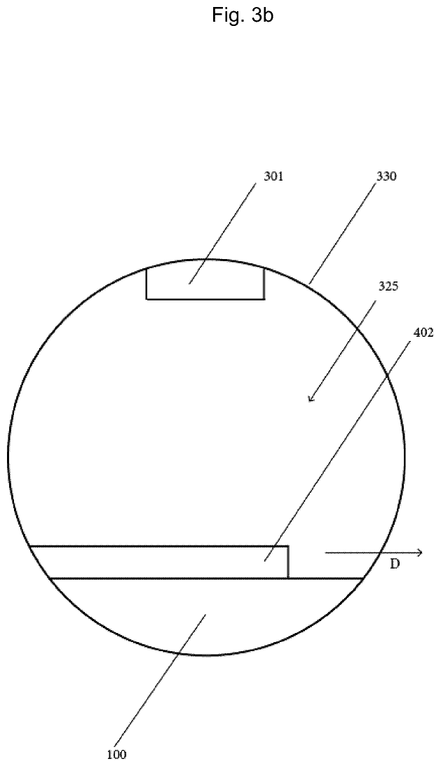

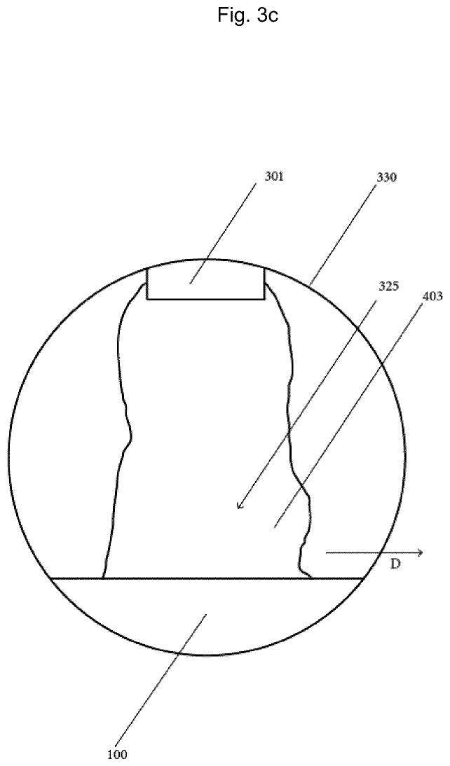

The cleaning assembly 300 according to the invention, illustrated in FIG. 1, further comprises:
a protection assembly comprising a mechanical protection element 301 for protecting the wave transducer 105 and covering the transducer 105 so that the transducer 105 is comprised between the mechanical protection element 301 and the optical surface 100. The mechanical protection element 301 defines, with the optical surface 100, at least one opening 325 able to allow the ultrasonic wave to propagate over the optical surface 100 outside of the protection assembly for protecting the cleaning assembly 300;
a sealing element disposed in the vicinity of the opening 325, not depicted in FIG. 1 but described with reference to FIGS. 3a to 3c, and able to limit the passage of liquid through the opening 325.

No restriction is attached to the mechanical protection element 301, which is preferably rigid.

No restriction is imposed on the shape of the mechanical protection element 301. In FIG. 1, the mechanical protection element 301 takes the form of a rectangular parallelepiped or of a cube, depending on its dimensions in the plane of the optical surface 100. The contact surface for the contact between the mechanical protection element 301 and the optical surface 100 is therefore a rectangle or square. However, the mechanical protection element 301 may, as a variant, be parabolic, and its contact surface for contact with the optical surface 100 is therefore a circle or an oval.

Furthermore, no restriction is imposed on the shape of the opening 325. This may, for example, be a rectangular slot extending over all or part of one side of the rectangle or of the square that constitutes the contact surface for contact between the mechanical protection element 301 and the optical surface 100. This is notably on the side oriented in the direction D of propagation of the ultrasonic wave generated by the transducer 105, so as to allow the ultrasonic wave to propagate out of the mechanical protection element in the direction D of propagation. When the contact surface for contact between the optical surface 100 and the mechanical protection element 301 is a circle or an oval, the opening 325 may extend over a portion of the circle or of the oval, notably a portion lying on the path of the sound wave propagating in the direction D of propagation.

The opening 325 notably defines a space 335 between the mechanical protection element 301 and the optical surface 100, the space 335 being of a dimension greater than half the amplitude of the sound wave generated by the transducer 105, so as to allow the wave to pass.

However, the size of the opening 325 needs to be limited so as to make it easier to maintain the fluid tightness of the inside of the mechanical protection element 301; for example, the size needs to be less than 100 micrometers.

Thus, the opening 325 advantageously makes it possible to maximize the mechanical protection afforded to the transducer 105 while at the same time allowing ultrasonic waves to pass in the direction D of propagation.

For example, the distance 335 may be greater than 10 nanometers, for example equal to 20 or 30 nanometers. As a variant, the distance 335 may be greater than 10 micrometers, for example equal to 20 or 30 micrometers.

As illustrated in FIG. 1, a non-zero distance 350 may be provided between the substrate and the mechanical protection element 301, so as not to disrupt the ultrasonic wave generated as it travels over the upper surface of the substrate 110 before reaching the optical surface 100. For this purpose, the distance 350 may be greater than 10 nanometers, or even greater than 100 nm, or even greater than 500 nm.

When the electrodes 120 and 130 are comprised between the substrate 110 and the optical surface 100, the distance 350 may be non-zero insofar as the thickness of the substrate 110 is greater than half the amplitude of the ultrasonic waves generated. The bulk associated with the cleaning assembly 300 is thus reduced.

FIG. 1 also depicts the vicinity 330 of the opening 325, defining what is situated close to the opening 325. The size of this vicinity 330 may vary, and may notably be dependent on the size of the opening and on the dimensions and shape of the mechanical protection element. For example, the vicinity 330 may consist of any point in space that is situated less than a predetermined distance away from the opening 325. The predetermined distance may be a fraction of a dimension of the mechanical protection element 301, such as one fifth, one tenth or one twentieth of a horizontal dimension of the mechanical protection element 301, or may be a dimension parallel to the plane of the optical surface 100.

The sealing element is advantageously situated in the vicinity 330 of the opening 325, so as to improve the fluid tightness between the inside and the outside of the cleaning assembly 300.

The mechanical protection element 301 is fixed on the optical surface 100 via a fixing element 340 of the protection assembly, which may be an adhesive, an adhesive film or an adhesive foam. The fixing element 340 may notably be spread at the contact surface for contact between the mechanical protection element 301 and the optical surface 100, with the exception of the contact surface corresponding to the opening 325, except in the embodiment of FIG. 3c, which will be described later. For example, the fixing element 340 may be distributed over three sides of the rectangle or square that forms the contact surface, with the exception of the side oriented in the direction D of propagation of the ultrasonic waves generated from the substrate 110.

FIG. 3a shows a sealing element according to a first embodiment, placed in the vicinity 330 of the opening 325.

The sealing element is a rubber component 401 disposed in the opening 325 in such a way as to obstruct same, connected to the mechanical protection element 301 and in contact with the optical surface 100. The contact with the optical surface 100 may be linear contact so as to make it easier for the component 401 to deform in order to allow the ultrasonic wave to pass. The sealing element is able both to improve the fluid tightness of the cleaning assembly 300, so as to protect the transducer 105, and at the same time allow ultrasonic waves generated to pass in the direction D to the outside of the mechanical protection element 301.

The component 401 may have a triangular cross section as depicted in FIG. 3a, to make it easier to attach to the mechanical protection element 301 while at the same time ensuring linear contact with the optical surface 100. The component 401 may have a maximum thickness, in the direction D of propagation, that is less than 2 mm, notably less than 1 mm or even less than 500 μm.

FIG. 3b shows a sealing element according to a second embodiment, placed in the vicinity 330 of the opening 325.

The sealing element is a hydrophobic or superhydrophobic coating 402 of the optical surface 100 disposed in the vicinity of the opening 325 of the mechanical protection element 301. It is preferentially disposed at least partially on the optical surface in the immediate vicinity of the opening and at the very least on the outside of the mechanical protection element 301 in the direction D of propagation. As a preference, the hydrophobic or superhydrophobic coating 402 is disposed on the optical surface facing the opening 325.

As an alternative or in addition, the hydrophobic or superhydrophobic coating 402 is disposed on a wall of the mechanical protection element 301 that forms the opening 325.

The hydrophobic or superhydrophobic coating 402 makes it possible to improve the sealing of the cleaning assembly so as to protect the transducer 105 without impact on the passage of the generated ultrasonic waves toward the outside of the mechanical protection element 301 in the direction D of propagation.

FIG. 3c shows a sealing element according to a third embodiment, placed in the vicinity 330 of the opening 325. According to the third embodiment, the sealing element performs a function of attaching the mechanical protection element 301 to the optical surface. The sealing element may notably be an adhesive or an adhesive foam 403, the properties of which allow the ultrasonic wave to pass through it. In particular, the hardness associated with the sealing element is greater than a predetermined threshold hardness, so as to reduce the absorption of the ultrasonic wave as it passes through the sealing element. The adhesive or adhesive foam 403 may have a maximum width, in the direction D of propagation, that is less than 2 mm, notably less than 1 mm or even less than 500 μm. The adhesive or adhesive foam 403 may have a maximum width, in the direction perpendicular to the direction D of propagation, that is less than 3 mm, notably less than 1 mm or even less than 500 μm.

The sealing element may thus form the one same single element with the fixing element 340 set out hereinabove. Thus, the mechanical protection element 301 is fixed in the one same step by spreading the foam or the adhesive over the entire contact surface for contact between the mechanical protection element 301 and the optical surface 100.

The sealing elements set out hereinabove may also be combined. In particular, the hydrophobic or superhydrophobic coating 402 may be used in combination with the rubber component 401 or with the adhesive foam or adhesive 403.

Referring once again to FIG. 1, the cleaning assembly 300 according to the invention may further comprise at least a covering of a material that absorbs electromagnetic waves and is able to limit the electromagnetic radiation from the wave transducer outside of the cleaning assembly. The invention applies to any material that has the property of absorbing electromagnetic waves. For example, as an alternative to a metallic material, the covering may comprise a layer of textile printed with at least one conducting ink in at least one pattern comprising printed zones and non-printed zones in an arrangement suited to a corresponding range of absorption frequencies. In what follows, it is considered, solely by way of illustration, that the material that absorbs electromagnetic waves is a metallic material.

The covering of the protection assembly may comprise:
an inner metallic layer 302 of the mechanical protection element 301, oriented toward the transducer 105, and/or an outer metallic layer 303 of the mechanical protection element, on an opposite face of the mechanical protection element 301 from the transducer 105. The mechanical protection element 301 may comprise a body made from a nonmetallic material, for example a plastic, as well as one and/or the other of the metallic coverings 301 and 302. In a variant, the mechanical protection element 301 may itself be made of metal and thus constitute a metallic covering element per se, in which case neither of the metallic coverings 301 and 302 is added; and/or
a metallic layer 320 on an opposite face 360 of the optical surface 100 from the transducer 105, or a metallic layer 310 serving to join the substrate 110 to the optical surface 100, as described hereinabove. Thus, when a metallic layer 110 is provided to join the substrate 110 to the optical surface 100, there is no need to provide the metallic layer 320 as well. However, when the join between the substrate 110 and the optical surface 100 is nonmetallic, it is easier to apply a metallic layer 320 to the face 360. Advantageously, the metallic joining layer 310 may have a surface area greater than that of the substrate 110, as depicted in FIG. 1. The electromagnetic radiation directed toward the face 360 of the optical surface 100 is thus limited.

Advantageously, the protection assembly protecting the cleaning assembly 300 comprises a metallic covering element 302 or 303 associated with the protection element 301 and a metallic covering element 310 or 320 associated with the optical surface 100, so as to constitute a Faraday cage with the exception of the opening 325. The benefit of an opening 325 of small size will therefore be all the better appreciated, so as to limit electromagnetic losses to outside of the cleaning assembly 300. Thus, the cleaning assembly 300 may be positioned near to other devices, having other functions, without disrupting the operation thereof.

Note that the metallic covering or the metallic coverings may be a continuous metallic layer or a discontinuous layer, such as a mesh, the mesh size being determined from parameters of the ultrasonic wave generated by the transducer 105, such as notably the frequency or wavelength of the ultrasonic wave. Such determination is well known and not described further.

Note that the cleaning assembly 300 according to the invention may comprise several transducers 105, for example oriented in different directions. Each transducer 105 may comprise a dedicated mechanical protection element 301, and a sealing element as described hereinabove.

In a variant, the mechanical protection element 301 may be shared between several transducers 105. The mechanical protection element may then comprise:
an opening 325 shared between the various transducers 105 with a sealing element in common;
an opening 325 for each transducer 105, with a sealing element disposed in the vicinity of each opening 325.

Of course, the invention is not limited to the examples that have just been described, and numerous modifications may be made to these examples without departing from the scope of the invention.

What is claimed is:

1. A protection assembly for a cleaning assembly including a cleaning unit and an optical surface, the cleaning unit including at least one wave transducer intended to be acoustically coupled to the optical surface,
the protection assembly comprising a mechanical protection element configured to cover the wave transducer so that the wave transducer is positioned between the mechanical protection element and the optical surface,
the mechanical protection element being configured to define, with the optical surface, at least one opening able to allow the ultrasonic wave to propagate over the optical surface outside of the mechanical protection element; and
a sealing element disposed near the opening and able to limit the passage of liquid through the opening.

2. The protection assembly as claimed in claim 1, wherein the opening is configured to have a dimension, normal to a direction of propagation of the ultrasonic waves, that is greater than or equal to half the amplitude of the ultrasonic waves generated by the transducer.

3. The protection assembly as claimed in claim 1, wherein the sealing element includes a hydrophobic or superhydrophobic coating in the vicinity of the opening, the hydrophobic or superhydrophobic coating being configured to at least partially cover the optical surface and/or at least partially cover the mechanical protection element.

4. The protection assembly as claimed in claim 1, wherein the sealing element includes a fixing element configured to be disposed between the mechanical protection element and the optical surface.

5. The protection assembly as claimed in claim 4, wherein the fixing element an adhesive foam or an adhesive able to allow some of the ultrasonic waves generated by the transducer to propagate through the opening.

6. The protection assembly as claimed in claim 1, wherein the sealing element includes a rubber component disposed in the opening and connected to the mechanical protection element and configured to be in contact with the optical surface.

7. The protection assembly as claimed in claim 1, wherein the mechanical protection element is configured to be fixed to the optical surface by an adhesive or an adhesive foam spread on each side of the opening.

8. The protection assembly as claimed in claim 1, further comprising a covering of a material that absorbs electromagnetic waves and is able to limit the electromagnetic radiation from the wave transducer outside of the cleaning assembly.

9. A unit for cleaning an optical surface comprising at least one wave transducer intended to be acoustically coupled to the optical surface,
the wave transducer including a piezoelectric element and electrodes of opposite polarity in contact with the piezoelectric element, and being configured to generate at least one ultrasonic wave propagating in the optical surface; and
a protection assembly including a mechanical protection element configured to cover the wave transducer so that the wave transducer is positioned between the mechanical protection element and the optical surface, the mechanical protection element being configured to define, with the optical surface, at least one opening able to allow the ultrasonic wave to propagate over the optical surface outside of the mechanical protection element, and a sealing element disposed near the opening and able to limit the passage of liquid through the opening.

10. A cleaning assembly comprising:
an optical surface; and
a cleaning unit or cleaning the optical surface, the cleaning unit including at least one wave transducer intended to be acoustically coupled to the optical surface, the wave transducer including a piezoelectric element and electrodes of opposite polarity in contact with the piezoelectric element, and being configured to generate at least one ultrasonic wave propagating in the optical surface and a protection assembly including a mechanical protection element configured to cover the wave transducer so that the wave transducer is positioned between the mechanical protection element and the optical surface, the mechanical protection element being configured to define, with the optical surface, at least one opening able to allow the ultrasonic wave to propagate over the optical surface outside of the mechanical protection element, and a sealing element disposed near the opening and able to limit the passage of liquid through the opening.
